(19) United States
(12) Patent Application Publication
(10) Pub. No.: US 2010/0065427 A1
(43) Pub. Date: Mar. 18, 2010

(54) MICROFLUIDIC CHIP AND ANALYTICAL METHOD

(75) Inventor: Machiko FUJITA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/560,722

(22) Filed: Sep. 16, 2009

(30) Foreign Application Priority Data
Sep. 18, 2008 (JP) P2008-240065

(51) Int. Cl. G01N 27/453; G01N 27/447

(52) U.S. Cl. 204/451; 204/601

(57) ABSTRACT

A microfluidic chip includes: a channel which is provided on a first portion of a surface of a substrate part, the channel being used for separating a substance subject to analysis by electrophoresis and adding a reaction reagent with a nozzle to the substance separated by electrophoresis; and an absorption region which is provided on a second portion of the surface of the substrate part, and which absorbs the reaction reagent, the second portion being different from the first portion.

This application is based upon and claims the benefit from Japanese patent application No. 2008-240065, filed on Sep. 18, 2008, the disclosure of which is incorporated herein in its entirety by reference.

### BACKGROUND OF THE INVENTION

1. Field of the Invention

The present invention relates to a microfluidic chip which is used in analysis of samples containing biological substances or chemical substances, and to an analytical method which uses this microfluidic chip.

2. Description of Related Art

As a method of analyzing or identifying substances subject to analysis such as biological substances or chemical substances, electrophoresis, chromatography, or the like is employed on samples containing the subject substance. In these analytical methods, separation and measurement are conducted in a capillary tube or well plate with respect to a sample containing the subject substance. In particular, in the case where the quantity of the sample itself is small, a “multidimensional analysis” is preferable in order to conduct a more highly accurate separation and identification of the subject substance. In the multidimensional analysis, multiple analyses are conducted using a “microfluidic chip” in which multiple channels of small volume are microfabricated.

For example, M. Fujita et al., “Journal of Chromatography, A, 1111, 2, (2006),” pp. 200-205, discloses a multidimensional analysis system using channels which are fabricated in the microfluidic chip surface. This system separates the subject substance contained in the sample by capillary electrophoresis, further runs a laser along the channels on the chip using a Matrix-Assisted Laser Desorption Ionization Mass Spectrometry apparatus (MALDI-MS), ionizes the subject substance, and obtains its spot position and molecular weight information.

However, in a conventional microfluidic chip, there is the problem that the sample solution dries up when the sample is introduced into the channel and when electrophoresis is performed. In order to solve the aforementioned problem, and in order to prevent drying of the sample without contaminating the content within the channel, the inventors of the present patent application have disclosed a technology relating to a microfluidic chip. This microfluidic chip includes a substrate part which has a groove-shaped channel in a surface separable from the substrate part, and a lid part which is positioned on the top face of the substrate part, and the substrate part and the lid part are separable (see, for example, PCT International Publication No. WO2005/026742).

The aforementioned lid part has the function of preventing drying of the sample solution at the time of sample introduction and at the time of electrophoresis.

On the other hand, for purposes of analysis in a subsequent phase in a process in which a reaction reagent or the like is directly added to the separated sample, it is necessary to remove the lid part, because it is a hindrance to this process. The reaction reagent may be, for example, a solution containing an ionization accelerator, dye solution, digestive enzyme solution, etc. Moreover, at the time of mass spectrometry by MALDI-MS, the lid part must be removed without fail, because it blocks the laser, and inhibits ionization.

For the aforementioned reasons, after termination of electrophoresis and freezing of the sample solution, the lid part is peeled and removed from the substrate part. Subsequently, the subject substance which was separated within the channel is dried so that its separated condition is not disturbed, and the reaction reagent is added to the dried subject substance, after which measurement is conducted. As the reaction reagent may be a solution in which an ionization accelerator called a matrix is dissolved, or the like. As one example of measurement, mixed crystal of the subject substance and the matrix is irradiated with a laser, and mass spectrometry or the like is conducted.

In order to ensure the reproducibility and reliability of analysis in a subsequent phase, it is necessary to add a reaction reagent into the channel without disturbing the separated condition. As an example of this subsequent-phase analysis, mass spectrometry will be described with a matrix solution used as the reaction reagent.

As a method of retaining a subject substance that has been separated and dried, and adding a matrix solution to the channel exposed by peeling off of the lid part, it is preferable to use a method in which the solution is instilled using a dispenser that employs a nozzle. This is because the dispenser method is an easy technique for controlling the additive amount and the addition position of the liquid, and because it has excellent reproducibility that is superior to that of an additive method which, for example, employs a sprayer. The dispenser nozzle discharges small liquid droplets of the matrix solution while the position of its distal end changes along the channel. The discharged matrix solution dries and crystallizes after mixing with the subject substance within the channel. In order to prevent the matrix solution from running out of the channel at the time of application of the solution, a structure is often preferentially adopted in which the chip surface outside the channel is made lyophobic, and the interior of the channel is made lyophilic.

The nozzle first moves (runs-up) over the substrate part surface outside the channel until it reaches a prescribed moving speed, and then transits the channel after reaching the prescribed speed. At this time, in conjunction with the start of run-up, a prescribed amount of the matrix solution is discharged from the nozzle. That is, during this run-up, the matrix solution—whose solvent had been evaporating and whose liquid composition had been changing during the standby period up to that point—is also discharged. Consequently, it is possible to apply a matrix solution of prescribed composition into the channel through which the nozzle subsequently passes at a prescribed speed.

However, in the case where a dispenser addition method is used as described above, it was found that the following problem exists. The greater part of the reaction reagent such as a matrix solution that is discharged during run-up is repelled from the lyophobic chip surface and thereby it is not applied to the surface, and ultimately adheres to the distal end of the nozzle. As a result, the distal end of the nozzle which is covered with a reaction reagent film moves outside the channel with gradual adherence of discharged reaction reagent, and film thickness grows. Subsequently, when run-up terminates, and when the nozzle position reaches the channel for the first time (i.e., when the nozzle position reaches the starting point of reaction reagent application in the channel), the excess reaction reagent adhering to the nozzle spreads widely over the lyophilic channel surface. At the same time, the problem arises that the subject substance within the channel is also swept along over a wide area, greatly disturbing positional information on the separated subject substance.

### SUMMARY OF THE INVENTION

An exemplary object of the invention is to provide a microfluidic chip which can apply a reaction reagent over the entirety of a channel without significantly disturbing the separated condition of the subject of analysis, particularly at the starting point of reaction reagent application, and an analytical method which uses the microfluidic chip.

A microfluidic chip according to a first exemplary aspect of the invention includes: a channel which is provided on a first portion of a surface of a substrate part, the channel being used for separating a substance subject to analysis by electrophoresis and adding a reaction reagent with a nozzle to the substance separated by electrophoresis; and an absorption region which is provided on a second portion of the surface of the substrate part, and which absorbs the reaction reagent, the second portion being different from the first portion.

An analytical method for conducting analysis using the microfluidic chip according to a second exemplary aspect of the invention, includes: separating the substance in the channel of the microfluidic chip by electrophoresis; exposing the channel; and having the nozzle transit the absorption region of the microfluidic chip in a state where the nozzle is discharging the reaction reagent, after which the nozzle transits the channel containing the substance that is separated in separating the substance.

### BRIEF DESCRIPTION OF THE DRAWINGS

FIG. 1A is a top view of a lid part of an example of component parts of a microfluidic chip according to a first exemplary embodiment.

FIG. 1B is a top view of a substrate part of an example of the component parts of the microfluidic chip according to the first exemplary embodiment.

FIG. 2 is a sectional view of the microfluidic chip according to the first exemplary embodiment taken along the A-A′ line of FIG. 1.

FIG. 3A to FIG. 3C are schematic views showing each process of analysis using the microfluidic chip according to the first exemplary embodiment.

FIG. 4A is a top view of the microfluidic chip in a reaction reagent addition process in the first exemplary embodiment.

FIG. 4B to FIG. 4D are sectional views of the microfluidic chip and a nozzle in each process of the reaction reagent addition process in the first exemplary embodiment.

FIG. 5A to FIG. 5C are sectional views which respectively show one example of an absorption region of the first exemplary embodiment.

FIG. 6A is a top view of a microfluidic chip, and schematically shows a problem to be solved by the first exemplary embodiment.

FIG. 6B to FIG. 6D are sectional views of the microfluidic chip and a nozzle in each process, and schematically show the problem to be solved by the first exemplary embodiment.

FIG. 7A is a top view of a lid part of an example of component parts of a microfluidic chip according to a second exemplary embodiment.

FIG. 7B is a top view of a substrate part of an example of the component parts of the microfluidic chip according to the second exemplary embodiment.

FIG. 7C is a top view of a substrate part of another example of the component parts of the microfluidic chip according to the second exemplary embodiment.

### EXEMPLARY EMBODIMENT

Below, exemplary embodiments are described with reference to drawings. In all the drawings, common components are assigned identical reference symbols, and description thereof is omitted as appropriate.

### Exemplary Embodiment 1

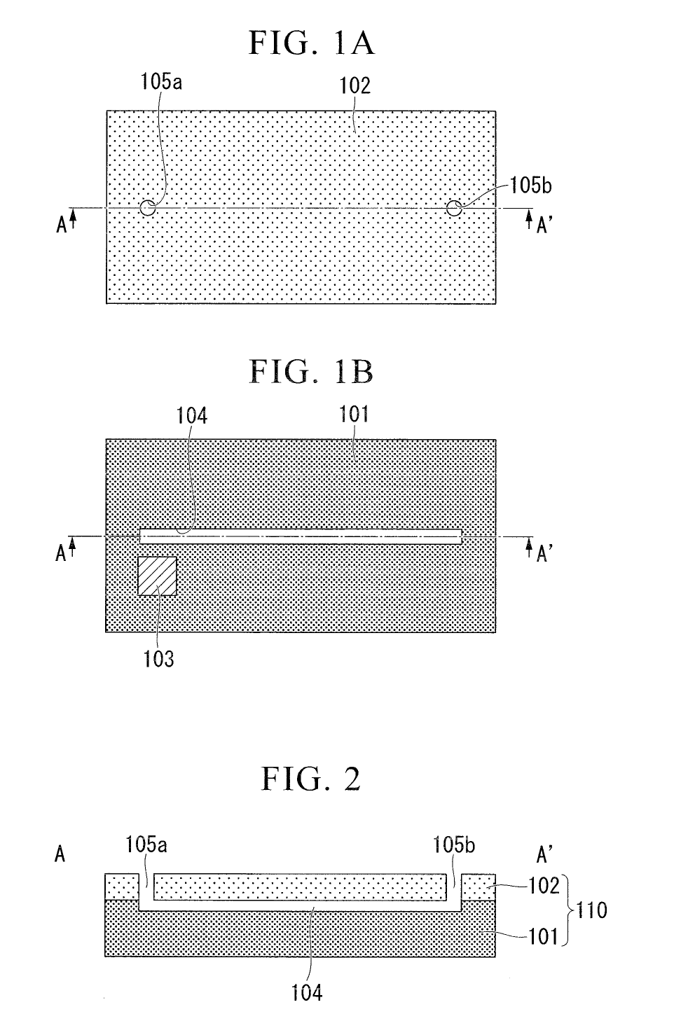

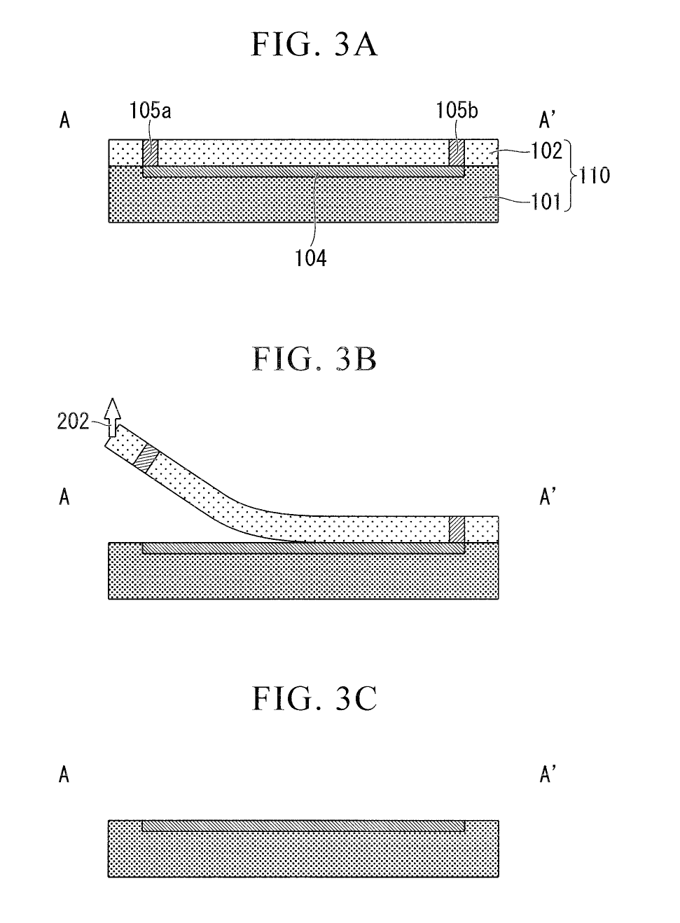

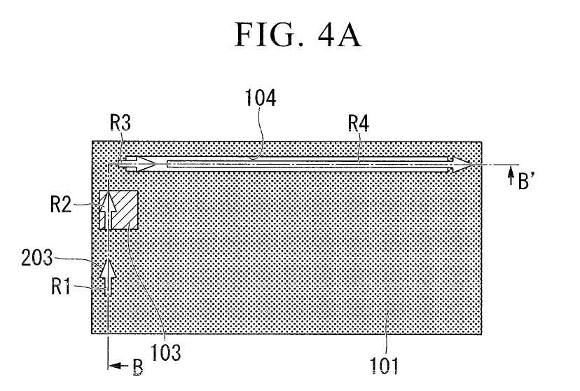

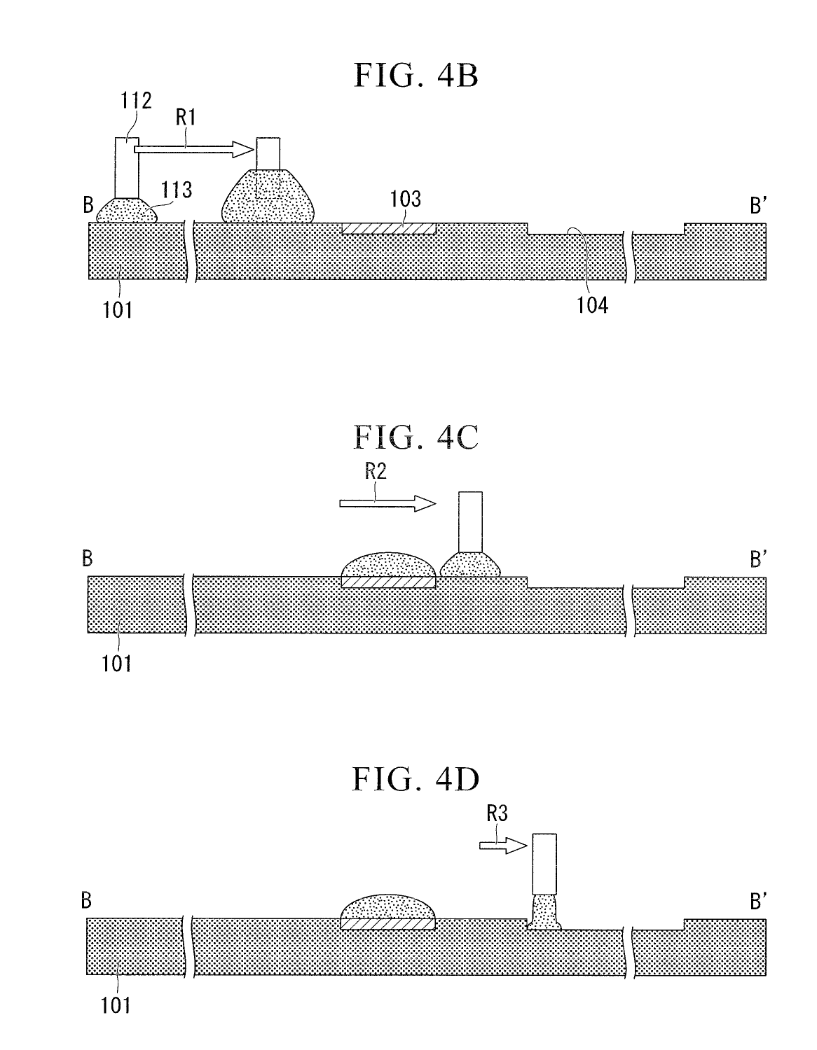

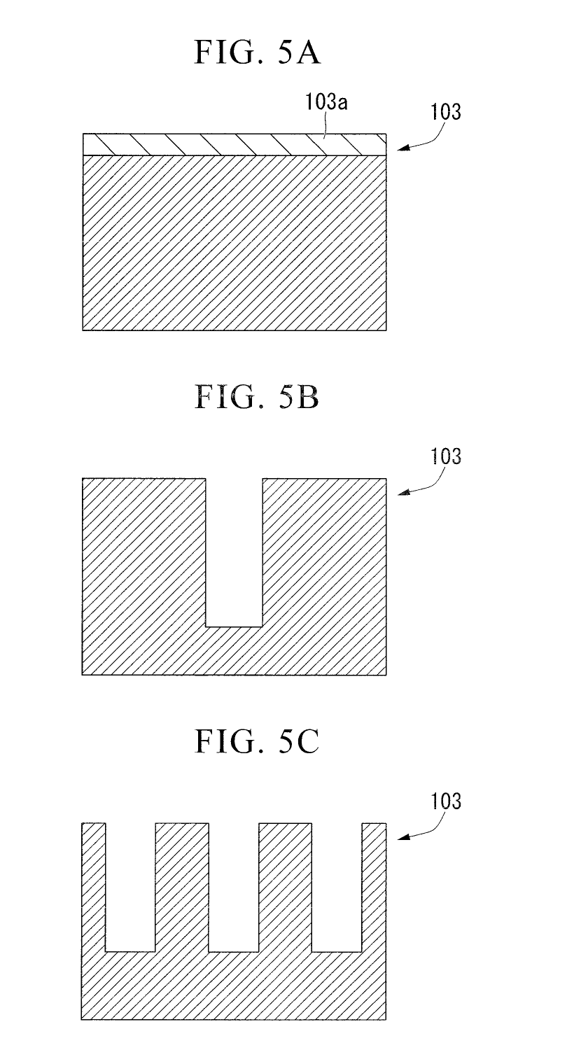

FIG. 1A and FIG. 1B show an example of component parts of a microfluidic chip according to a first exemplary embodiment. FIG. 1A is a top view of a lid part. FIG. 1B is a top view of a substrate part. FIG. 2 is an example of a sectional view of the microfluidic chip according to the first exemplary embodiment taken along the A-A′ line of FIG. 1. FIG. 3A to FIG. 3C are schematic views showing each process of analysis using the microfluidic chip according to the first exemplary embodiment. FIG. 4A to FIG. 4D are schematic views showing a reaction reagent addition process in the first exemplary embodiment. FIG. 4A is a top view of the microfluidic chip. FIG. 4B to FIG. 4D are sectional views of the microfluidic chip and a nozzle in each process. Arrow marks 203 (arrow marks R1 to R4) in FIG. 4A to FIG. 4D show the movement path and movement direction of a nozzle 112. FIG. 5A to FIG. 5C are sectional views which respectively show one example of an absorption region 103.

In the channel configuration illustrated in FIG. 1A, FIG. 1B, and FIG. 2, a substrate part 101 is provided on its top face with an absorption region 103, and a channel 104. The absorption region 103 is used to absorb a reaction reagent. The channel 104 is used to separate a sample containing a substance subject to analysis. The absorption region 103 has an absorption capacity which is capable of absorbing a prescribed liquid amount of the reaction reagent that is discharged from a nozzle during a run-up period. At least a portion of the channel 104 of the substrate part 101 is sealed by a lid part 102. The lid part 102 has liquid retention holes 105a and 105b. The liquid retention holes 105a and 105b are coupled with the channel 104, and hold liquid. It is preferable that the liquid retention holes 105a and 105b be arranged at positions corresponding to the two ends of the channel 104.

A description will now be given of the aforementioned prescribed liquid amount. When an optimal application amount A[L] at the application starting point in the channel 104 with a channel volume D[L] is given, it is preferable to have 0.2 D≦A≦30 D, and in the case of a matrix liquid in particular, it is preferable to have 0.2 D≦A≦20 D. That is, the excess reaction reagent adhering to the nozzle is absorbed by the absorption region 103 so that the application amount at the application starting point is the optimal application amount A[L] at the application starting point. As stated above, since the absorption region 103 only absorbs the excess reaction reagent adhering to the nozzle, it does not excessively absorb the reaction sample. This is because excessive absorption of reaction solution causes irregularities in signal detection intensity.

In the first exemplary embodiment, a description is given for the case where the sample is subjected to isoelectric point separation using a microfluidic chip, and mass spectrometry is subsequently conducted, that is, for the case where a matrix solution is used as the reaction reagent. However, the method of sample analysis according to the first exemplary embodiment is not limited thereto.

A sample containing, in addition to the subject substance, carrier ampholytes used for pH gradient formation is introduced into the channel 104 through the liquid retention holes 105a and 105b. Thereafter, an acid solution (anolyte) for pH gradient formation which is an electrode solution is introduced into one of the liquid retention holes (i.e., the liquid retention hole 105a), and a basic solution (catholyte) is introduced into the other retention hole (i.e., the liquid retention hole 105b) (the state shown in FIG. 3A). Next, electrode terminals for electric field application are inserted into the liquid retention holes 105a and 105b, and an electric field, which is used when performing separation of the subject substance within the channel 104, is applied between these electrode terminals.

Subsequently, electric field application is stopped when the subject substance is separated within the channel 104 at each isoelectric point, and then the substrate part 101 is cooled to thereby frozen the sample and the electrode solution. Next, while the sample and the electrode solution remain frozen, a force 202 is imparted to peel off the lid part 102, and the lid part 102 is peeled off from the substrate part 101 (the state shown in FIG. 3B). Furthermore, the substrate part 101 is placed in a vacuum atmosphere while still frozen, and is subjected to vacuum freeze-drying while the subject substance is maintained in a separated state (the state shown in FIG. 3C).

Next, the matrix solution is added to the substrate part 101, and drying operations are further conducted. A nozzle 112 of the dispenser commences run-up while discharging a matrix solution 113 (the state shown in FIG. 4B). The amount of solution adhering to the nozzle 112 gradually increases, but this adhesion of excess solution can be absorbed by the absorption region 103 and removed from the distal end of the nozzle as a result of transiting the absorption region 103 (the state shown in FIG. 4C). The nozzle 112 which has reached the prescribed moving speed during this time transits the channel 104 while discharging the solution (the state shown in FIG. 4D). Consequently, since the prescribed amount of liquid can be applied to the channel 104 from the starting point of matrix application in the channel, it is possible to uniformly add the matrix over the entirety of the channel 104 without significantly disturbing the position of the subject to analysis.

As a structure for achievement of matrix solution absorption capacity by the absorption region 103 of the chip of the first exemplary embodiment, it is possible, for example, to use an absorption region 103 having a lyophilic surface 103a such as shown in FIG. 5A. For example, by applying a coating or the like of lyophilic material to the absorption region 103, it is possible to retain the solution on the chip surface side, and prevent adhesion of the solution to the nozzle.

Alternatively, by forming a lyophilic groove-shaped structure in the absorption region 103 such as shown in FIG. 5B, it is possible to enhance the lyophilicity of the absorption region 103, and stably retain the solution by means of the groove wall faces.

Or, a lyophilic structure having a plurality of projections and depressions may be formed in the absorption region 103, such as shown in FIG. 5C. By this configuration, the lyophilicity of the absorption region 103 is increased, and it is possible to absorb larger volumes of solution.

Furthermore, it is also acceptable to have the absorption region 103 independent from the channel 104, and to provide one end of the absorption region 103 in the vicinity of one end of the channel 104. If the absorption region 103 is independent from the channel 104, it is possible to reliably retain excess matrix solution within the absorption region 103, and prevent it from flowing into the channel 104. However, it is necessary that one end of the absorption region 103 be provided in the vicinity of one end of the channel 104, and that it be possible to immediately move to the application starting point in the channel 104 after passage of the absorption region 103.

It is preferable that various aspects described above be appropriately combined for use.

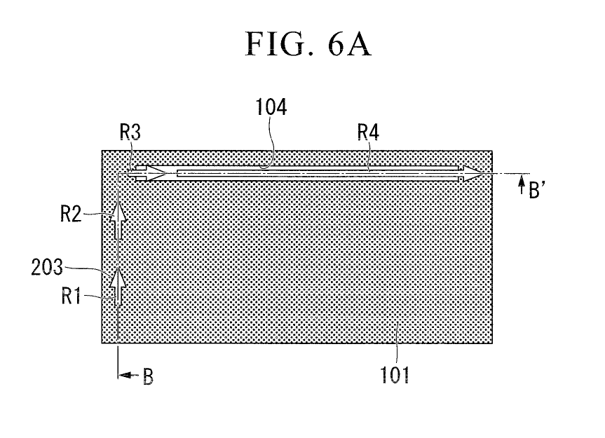

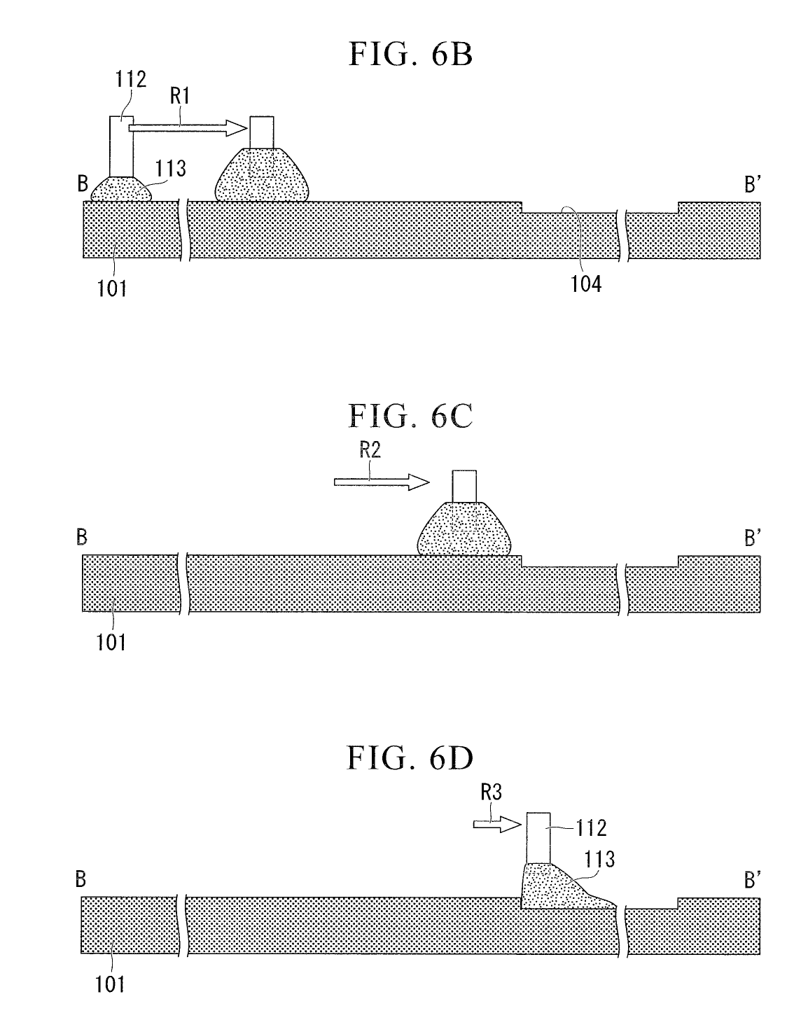

FIG. 6A to FIG. 6D are schematic views showing a reaction reagent application process for the case where a microfluidic chip is used without the absorption region 103. In particular, FIG. 6A is a top view of the microfluidic chip. FIG. 6B to FIG. 6D are sectional views of the microfluidic chip and a nozzle at each stage of the process. When a microfluidic chip that does not have the absorption region 103 is used, the greater part of the reaction reagent that is discharged during run-up is repelled by the lyophobic chip surface, is not applied, and adheres to the distal end of the nozzle 112 (the state shown in FIG. 6B). As a result, the distal end of the nozzle 112 which is covered with a film of the solution moves outside the channel while adhesions of discharged solution gradually develop, and film thickness grows (the state shown in FIG. 6C). Subsequently, when run-up terminates, and when the position of the nozzle 112 reaches the channel for the first time (i.e., when the nozzle position reaches the starting point of reaction reagent application in the channel), the excess reaction reagent adhering to the nozzle 112 spreads widely over the lyophilic channel surface (the state shown in FIG. 6D). As a result, the subject substance within the channel is also swept along over a wide area, thereby risking destruction of the separated condition of the subject substance.

In contrast, as described above, the microfluidic chip according to the first exemplary embodiment is able to solve the configurative problem that is illustrated by FIG. 6A to FIG. 6D.

As the material of the substrate part 101 of the first exemplary embodiment, it is preferable to use, for example, quartz, glass, silicone, or other materials which are suited to microfabrication. Furthermore, as the material of the substrate part 101, it is also possible to use materials which enable achievement of the intended microfabrication accuracy among plastic materials having high-level insulation properties such as polycarbonate, ABS, HDPE, and PMMA (polymethyl methacrylate).

Since an electric field is applied to the groove-shaped channel 104 that is formed on the top face of the substrate part 101, it is necessary to insulate the substrate part 101 itself from the migration solution within the groove-shaped channel 104. Consequently, as the substrate part 101, it is preferable to use a high-insulation material such as, for example, quartz or glass. When using a material with inferior insulation properties such as silicone as the substrate part 101, an insulating coating layer is provided on the inner wall of the groove-shaped channel to achieve electrical insulation relative to the migration solution within the groove-shaped channel. Or the groove-shaped channel portion of the substrate part 101 may be formed using a silicone oxide layer that is formed on top of the silicone substrate part.

As the material of the lid part 102 of the first exemplary embodiment, it is preferable to use a material which has excellent insulation properties and which enables the conduct of machining such as fabrication of the liquid retention holes. The material of the lid part 102 may be, for example, polymer resin material such as PDMS (polydimethylsiloxane); polyolefins such as PTFE (polytetrafluoroethylene), PP (polypropylene), PE (polyethylene), and polyvinyl chloride; or polyesters, etc. The lid part 102 is fabricated using die molding, extrusion molding, hot embossing, or the like.

The absorption region 103 is formed on the substrate part 101. Consequently, if the same material as the substrate part 101 mentioned above—e.g., quartz, glass, silicone, or the like—is used as the material of the absorption region 103 of the first exemplary embodiment, it is possible to fabricate the chip at low cost. In the case where an absorption region 103 which has a groove-shaped structure or a structure having a plurality of projections and depressions as described above is used, the absorption region 103 can be fabricated simultaneously with the channel 104, and the chip can be fabricated in a shorter time.

To form a hydrophilic surface in the absorption region 103, it is preferable to apply a method which forms a hydrophilic film. The material of hydrophilic film may be, for example, titanium oxides, or polymers whose base material is polyacrylamide, polyvinyl alcohol, carboxylmethyl cellulose, polyhydroxyalkyl methacrylate, polyoxyalkylene methacrylate, polyvinylpyrrolidone, phospholipid-polymer composites, 2-methacryloyloxyethyl phosphorylcholine copolymer.

Next, an explanation is given concerning the size of the absorption region 103, the distance relationship between the absorption region 103 and the channel 104, and the location of the absorption region 103 on the chip. The optimal application amount A[L] and the discharge amount D[L/mm] at the starting point of application in the channel 104 are values which vary according to channel structure and reaction reagent. The discharge amount D[L/mm] is expressed by unit time discharge amount E[L/s]×moving speed v[mm/s] (D=E×v).

The relation of the absorption amount C[L/mm²] of the absorption region 103, and area S[mm²] of the absorption region 103, the distance X1 [mm] from the discharge starting point to the absorption region 103 transit starting point, the distance X2 [mm] from the absorption region 103 transit starting point to its transit ending point, the distance X3 [mm] from the absorption region 103 transit ending point to the application starting point in the channel 104, and the solution drying amount F[L/S] are shown in the Formula (1) below.

A=[(X1+X2+X3)/v]×(E−F)−S×C Formula (1)

By conducting the above-described analytical method using a microfluidic chip of the above-described configuration as illustrated in the first exemplary embodiment, it is possible to add a reaction reagent such as a matrix solution over the entirety of a channel, particularly at the starting point of application, without significantly disturbing the separated condition of a subject substance.

That is, by forming an absorption region, it is possible to absorb excess reaction reagent in the absorption region, and remove it from the distal end of the nozzle before application of the reaction reagent to the channel. Consequently, as the prescribed amount can be applied from the starting point of reaction reagent application in the channel, it is possible to add a reaction reagent more uniformly over the entirety of the channel without significantly disturbing the separated condition of the subject to analysis.

### Exemplary Embodiment 2

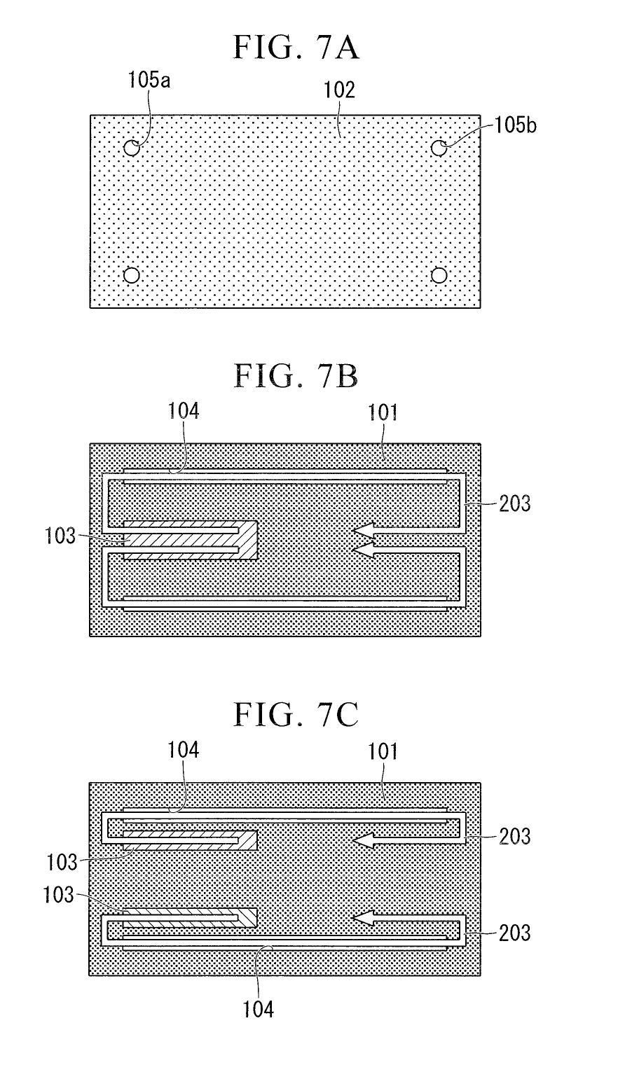

FIG. 7A to FIG. 7C show an example of component parts of a microfluidic chip according to a second exemplary embodiment. FIG. 7A is a top view of a lid part. FIG. 7B is a top view of a substrate part. FIG. 7C is a top view of a substrate part of another example. The shape of the channel 104 which is illustrated in the aforementioned FIG. 1B is configured into a single lane. However, the configuration of channels is not limited thereto, and it is also possible to conduct enlargement to a multi-lane type microchip in which a plurality of groove-shaped channels 104 are provided in combination on the top face of the substrate part 101, as illustrated in FIG. 7B and FIG. 7C. According to this type of configuration, it is possible to analyze a plurality of samples with one chip, thereby enabling cost reductions.

In the substrate part 101 shown in FIG. 7B, the absorption region 103 is made common to a plurality of channels 104. According to this configuration, the size of a single chip can be reduced, and further cost reductions are possible.

The analytical method of the second exemplary embodiment is similar to that of the aforementioned first exemplary embodiment. However, it differs in that the nozzle transits the shared absorption region 103 before the reaction reagent is applied to each channel. Accordingly, in order to fully remove excess reaction reagent that adheres to the nozzle, it is preferable either that the absorption capacity of the absorption region 103 be made greater than in the case of a single lane, or that after termination of application in a single lane, and after drying of the reaction reagent, application in the next lane be conducted.

As the material of the substrate part 101, lid part 102, and absorption region 103 of the second exemplary embodiment, the same materials as in the aforementioned first exemplary embodiment are optimal.

An explanation will now be given concerning the number of absorption regions 103. In the case where the microfluidic chip is provided with a plurality of channels 104, and where different solutions are applied to each channel 104, it is preferable that the absorption region 103 be provided by channel 104 as shown in FIG. 7C. On the other hand, in the case where the solution that is applied is common, it is optimal to share the absorption region 103 as shown in FIG. 7B, thereby enabling cost reductions.

By conducting the aforementioned analytical method using the aforementioned microfluidic chip 110, it is possible to add a reaction reagent such as a matrix solution without significantly disturbing the position of the subject substance, even at the starting point of application in the channel. In addition, cost reductions pertaining to the chip are possible.

### EXAMPLE

Using the below microfluidic chip, the present inventors demonstrated that it is possible to add a matrix solution which is a reaction reagent over the entirety of a channel without significantly disturbing the separated condition of a substance subject to analysis.

A substrate part 101 of a microfluidic chip according to an example has a configuration shown in FIG. 1B. The substrate part 101 is a rectangular synthetic quartz substrate part that has a length of 21 mm, a width of 42 mm and a thickness of 0.525 mm. The channel 104 of the example is engraved to a depth of 10 microns on the top face of the substrate part 101 by means of photolithography and dry etching. The channel 104 is a rectilinear groove with a length of 32 mm and a width of 1 mm, and one channel is formed on a single chip. The absorption region 103 of the example is formed with a depth of 10 microns in the surface of the substrate part 101. The absorption region 103 is provided in the vicinity of the channel 104. Within the absorption region 103, a columnar structure is uniformly formed with a diameter of 10 microns and a pitch of 20 microns. A liquid repellent fluoro coating is applied to the surface of the substrate part 101 apart from the absorption region 103 and the channel 104. A hydrophilic polyacrylamide coating is applied to the absorption region 103 and the channel 104.

The lid part 102 of the example has a length of 19 mm, a width of 44 mm, and thickness of 2 mm, and is made of a silicone resin (PDMS: Polydimethylsiloxane). Liquid retention holes 105a and 105b of the example with a diameter of 2 mm are opened in the lid part 102 at positions which correspond to the two ends of the channel 104. The lid part 102 is molded as follows: silicone resin material and a hardening agent are mixed, and cast into a molding die, and then heated for 1 hour at 150 degrees to thereby harden. As PDMS is a material that does not have strong adhesive force, it enables easy peeling and removal from the substrate part 101.

The microfluidic chip was mounted for analysis on a stage on a Peltier which had a cooling mechanism and a heating mechanism. As the subject substance, a fluorescently stained protein was used whose separated condition was capable of fluorescent observation. The sample for analysis (analytical sample) was a cIEF gel containing 2% carrier ampholytes (cIEF ampholytes) which forms a pH gradient within a channel in which voltage is applied, and 10% fluorescently stained protein (trypsin inhibitor) aqueous solution.

With respect to analysis, first, the analytical sample was introduced into the liquid retention holes 105a and 105b, after which it was also introduced into the channel 104 using capillary force. Next, one of the liquid retention holes (i.e., the liquid retention hole 105a) was filled with an electrode solution of 0.02M NaOH (pH 12.4), and the other liquid retention hole (i.e., the liquid retention hole 105b) was filled with an electrode solution of 0.1M H₃PO₄ (pH 1.9), and electrodes were inserted into both liquid retention holes 105a and 105b. Subsequently, 2.4 kV of voltage was applied for 6 minutes between the electrodes, and the isoelectric point markers underwent isoelectric point separation. The separated condition of the fluorescently stained protein within the channel 104 was observed using a fluorescent microscope.

The microfluidic chip was cooled immediately after observation using a Peltier table, and the analytical sample and the electrode solutions were frozen. Furthermore, the lid part 102 was peeled and removed from the substrate part 101 while maintaining the frozen state of the analytical sample and the electrode solutions. Subsequently, the channel 104 underwent fluorescent observation, and it was confirmed that the separated condition of the fluorescently stained protein was maintained even after removal of the lid part 102, and conduct of the freeze-drying process.

As the matrix solution, a solvent of 30% water and 70% acetonitrile was used, and mixing was conducted so that a TFA concentration of 0.05% and a sinapic acid concentration of 20 micro mol/milliliter was finally obtained. This matrix solution was instilled using a metallic needle nozzle for dispenser of 32 G (an inner diameter of 0.1 mm, and an outer diameter of 0.23 mm). The nozzle began movement while discharging the matrix solution, first conducted run-up as it transited the absorption region 103, and then after transiting the channel 104, the nozzle ceased movement and discharge of the liquid.

The aforementioned substrate part 101 was put into a mass spectrometer, the signal detection intensities of the sinapic acid and the fluorescently stained protein were measured, and the uniformity of the signal detection intensity of the sinapic acid and the separated condition of the fluorescently stained protein were evaluated. As a result, it was confirmed that irregularity in the signal detection intensity of the sinapic acid was suppressed within about 30 percent of the average value. With respect to the separated condition obtained from the signals of the fluorescent protein, it was also confirmed that the separated condition was maintained at the time of fluorescent observation.

From the foregoing experiment, it was shown that it is possible to add a matrix solution which is a reaction reagent over the entirety of a channel without significantly disturbing the separated condition of the subject substance by conducting: a step of electrophoretically separating a sample containing the subject substance using a microfluidic chip which is configured with the substrate part 101 that has the absorption region 103 and the channel 104, and a lid part in which the liquid retention holes 105a and 105b are provided; a step of exposing the channel 104 by peeling off the lid part 102; and a step of having the nozzle of a dispenser transit the absorption region 103 while discharging the matrix solution, and subsequently having it transiting the channel 104.

A third exemplary embodiment of the invention is the microfluidic chip, in which the absorption region includes a lyophilic surface. Furthermore, a fourth exemplary embodiment of the invention is the microfluidic chip in which the absorption region includes a structure having a grooved shape. Moreover, a fifth exemplary embodiment of the invention is the microfluidic chip, in which the absorption region includes a structure having a plurality of projections and depressions. Furthermore, a sixth exemplary embodiment of the invention is the microfluidic chip, in which one end of the absorption region is provided in a vicinity of one end of the channel. Moreover, a seventh exemplary embodiment of the invention is the microfluidic chip, in which a plurality of the channels are provided on the first portion of the surface of the substrate part, and the absorption region is shared among a plurality of the channels. Furthermore, an eighth exemplary embodiment of the invention is the microfluidic chip, in which a plurality of the channels are provided on the first portion of the surface of the substrate part, and a plurality of the absorption regions are provided on the second portion of the surface of the substrate part.

An exemplary advantage according to the invention is that, at the starting point of application in the channel, it is possible to add a reaction reagent without significantly disturbing the separated condition of the subject substance.

The microfluidic chip according to the exemplary embodiments illustrated above and the analytical method using it may be utilized with the objective of enhancing the reproducibility and reliability of analysis in additional analysis which utilizes a sample that has already been separated on the microfluidic chip, for example, in analytical processes pertaining to a sample that is provided for mass spectrometry or bioassay analysis.

While the invention has been particularly shown and described with reference to exemplary embodiments thereof, the invention is not limited to these embodiments. It will be understood by those of ordinary skill in the art that various changes in form and details may be made therein without departing from the spirit and scope of the resent invention as defined by the claims.

What is claimed is:

1. A microfluidic chip comprising:
a channel which is provided on a first portion of a surface of a substrate part, the channel being used for separating a substance subject to analysis by electrophoresis and adding a reaction reagent with a nozzle to the substance separated by electrophoresis; and
an absorption region which is provided on a second portion of the surface of the substrate part, and which absorbs the reaction reagent, the second portion being different from the first portion.

2. The microfluidic chip according to claim 1, wherein the absorption region includes a lyophilic surface.

3. The microfluidic chip according to claim 1, wherein the absorption region includes a structure having a grooved shape.

4. The microfluidic chip according to claim 1, wherein the absorption region includes a structure having a plurality of projections and depressions.

5. The microfluidic chip according to claim 1, wherein one end of the absorption region is provided in a vicinity of one end of the channel.

6. The microfluidic chip according to claim 1, wherein a plurality of the channels are provided on the first portion of the surface of the substrate part, and the absorption region is shared among a plurality of the channels.

7. The microfluidic chip according to claim 1, wherein a plurality of the channels are provided on the first portion of the surface of the substrate part, and a plurality of the absorption regions are provided on the second portion of the surface of the substrate part.

8. An analytical method for conducting analysis using the microfluidic chip according to claim 1, the method comprising:
separating the substance in the channel of the microfluidic chip by electrophoresis;
exposing the channel; and
having the nozzle transit the absorption region of the microfluidic chip in a state where the nozzle is discharging the reaction reagent, after which the nozzle transits the channel containing the substance that is separated in separating the substance.
